(19) United States
(12) Patent Application Publication
(10) Pub. No.: US 2022/0076223 A1
(43) Pub. Date: Mar. 10, 2022

(54) KIOSK METHOD AND APPARATUS

(71) Applicant: Godwud, LLC, Missouri City, TX (US)

(72) Inventors: John Jeffery Patti, College Station (US); Steven Scott Pershern, Dallas (US)

(21) Appl. No.: 17/464,905

(22) Filed: Sep. 2, 2021

Related U.S. Application Data
(60) Provisional application No. 63/074,572, filed on Sep. 4, 2020.

(51) Int. Cl. G06Q 20/18; H04L 29/06; H04L 9/06; H04L 9/08

(52) U.S. Cl. CPC G06Q 20/18; H04L 63/0435; G06Q 2220/00; H04L 9/0861; H04L 65/4007; H04L 9/0631

(57) ABSTRACT

A method is provided. A session is established with a server by a user, which included generating a symmetric session key, encrypting the symmetric session key with the server's public key to generate an encrypted session key, and transmitting the encrypted session key to the server. A user's physical characteristics are measured, and the user's physical characteristics are formatted into a transmission message. The transmission message is encrypted to generate an encrypted transmission message with the symmetric session key. The encrypted transmission message is transmitted to the server. A receive message is received from the server. The receive message is decrypted with the symmetric session key into a decrypted message, and the decrypted message is formatted into ordered bat data. The ordered bat data is then displayed.

### CROSS-REFERENCE

This patent claims priority to U.S. Provisional Patent Application Ser. No. 63/074,572, which was filed on Sep. 4, 2020, and which is hereby incorporated by reference for all purposes.

### TECHNICAL FIELD

The disclosure relates generally to a point-of-sale terminal and, more particularly, to an in-store kiosk.

### BACKGROUND

Transitionally, fitting of a baseball or softball entailed making sophisticated measurements within a batting cage. A batter would typically hit hundreds of ball with various bats to determine which bat would have the best performance. Often such equipment was cost prohibitive in most retail spaces and were rather rare. The reason is that the equipment was expensive, required a substantial footprint, and required a large number of test bats (which were expensive by themselves with low margins for the retailer) to remain in stock. Some examples of these conventional systems are as follows: U.S. Pat. Nos. 10,387,930; 7,048,638; and U.S. Patent Pre-Grant Publ. 2007/0065791.

However, with the advent of one of the newest innovations is sports from WHICHBAT (which enables a user to input basic physical data to generate an order list of the best performing bats), there is a need for a kiosk that can take advantage of this innovation.

### SUMMARY

An embodiment of the present disclosure, accordingly, provides an apparatus. The apparatus comprises: an interface; a static sensor that is configured to measure height and weight of a user; a strength sensor that is configured to measure an indicia of strength of the user; a sensor interface that is in communication with the static sensor and the strength; communication circuitry that is configured to communicate with a network; a controller that is in communication with the sensor interface and the communication circuitry, wherein the controller includes: a data collector that is configured to receive sensor data from the sensor interface, wherein the sensor data the height, weight, and indicia of strength; a database that is configured to include bat data for a plurality of bats; a formatter that is configured to: generate a transmission message that includes the height, the weight, and the indicia of strength; communicate with the database; receive decrypted display data; and generate display data from the bat data and the decrypted display data; and an encryption engine that is configured to: encrypt the transmission message; and decrypt a receive message to generate the decrypted display data.

In accordance with an embodiment of the present disclosure, the controller further comprises a processor that is in communication with a memory.

In accordance with an embodiment of the present disclosure, the controller includes a software stack that includes: a kernel layer; an interface layer that is configured to communicate with the kernel layer; and an application layer that includes the data collector, the database, the formatter, and the encryption layer, wherein the application layer is configured to communicate with the interface layer.

In accordance with an embodiment of the present disclosure, sensor interface further comprises a microcontroller.

In accordance with an embodiment of the present disclosure, the software stack is a first software stack, and wherein the microcontroller further comprises a second software stack.

In accordance with an embodiment of the present disclosure, the static sensor further comprises: a height sensor; and a weight sensor.

In accordance with an embodiment of the present disclosure, the height sensor further comprises a camera.

In accordance with an embodiment of the present disclosure, the second software stack further comprises: a sensor hardware abstraction layer (HAL) that is configured to communication with the height sensor, the weight sensor, and the strength sensor; and an interface HAL that is configured to communicate the sensor data to the controller.

In accordance with an embodiment of the present disclosure, the strength sensor further comprises a plurality of strength sensors.

In accordance with an embodiment of the present disclosure, a method is provided. The method comprises: establishing a session with a server by a user, wherein the step of establishing includes: generating a symmetric session key; encrypting the symmetric session key with the server's public key to generate an encrypted session key; and transmitting the encrypted session key to the server; measuring a user's physical characteristics; formatting the user's physical characteristics into a transmission message; encrypting the transmission message to generate an encrypted transmission message with the symmetric session key; transmitting the encrypted transmission message to the server; receiving a receive message from the server; decrypting the receive message with the symmetric session key into a decrypted message; formatting the decrypted message into ordered bat data; and display the ordered bat data.

In accordance with an embodiment of the present disclosure, the step of encrypting further comprises encrypting the transmission message with Advanced Encryption Standard (AES).

In accordance with an embodiment of the present disclosure, the ordered bat data further comprises a listing of bats in an order based at least in part on the user's physical characteristics.

In accordance with an embodiment of the present disclosure, the user's physical characteristics further comprises height, weight, age, and indicia of strength of a user.

In accordance with an embodiment of the present disclosure, an apparatus is provided. The apparatus comprising: a touchscreen interface; height and weight sensors that are, respectively, configured to measure height and weight of a user; a strength sensor that is configured to measure an indicia of strength of the user; a sensor interface that is in communication with the static sensor and the strength; communication circuitry that is configured to communicate with a network; a controller that is in communication with the sensor interface and the communication circuitry, wherein the controller includes: a data collector that is configured to receive sensor data from the sensor interface, wherein the sensor data the height, weight, and indicia of strength; a database that is configured to include bat data for a plurality of bats; a formatter that is configured to: generate a transmission message that includes the height, the weight, and the indicia of strength; communicate with the database; receive decrypted display data; and generate display data from the bat data and the decrypted display data; and an encryption engine that is configured to: generate a symmetric session key; encrypt the symmetric session key with a public key; encrypt the transmission message; and decrypt a receive message to generate the decrypted display data.

In accordance with an embodiment of the present disclosure, the second software stack further comprises: a sensor hardware abstraction layer (HAL) that is configured to communication with the height sensor, the weight sensor, and the strength sensor; and an interface HAL that is configured to communicate the sensor data to the controller.

In accordance with an embodiment of the present disclosure, the communication circuitry is a wireless front end that is configured to communicate with a wireless router.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is an example system in accordance with a preferred embodiment of the present disclosure;

FIG. 2 is an example of the kiosk of FIG. 1; and

FIG. 3 is an example operation of the system of FIG. 1.

### DETAILED DESCRIPTION

Refer now to the drawings wherein depicted elements are, for the sake of clarity, not necessarily shown to scale and wherein like or similar elements are designated by the same reference numeral through the several views.

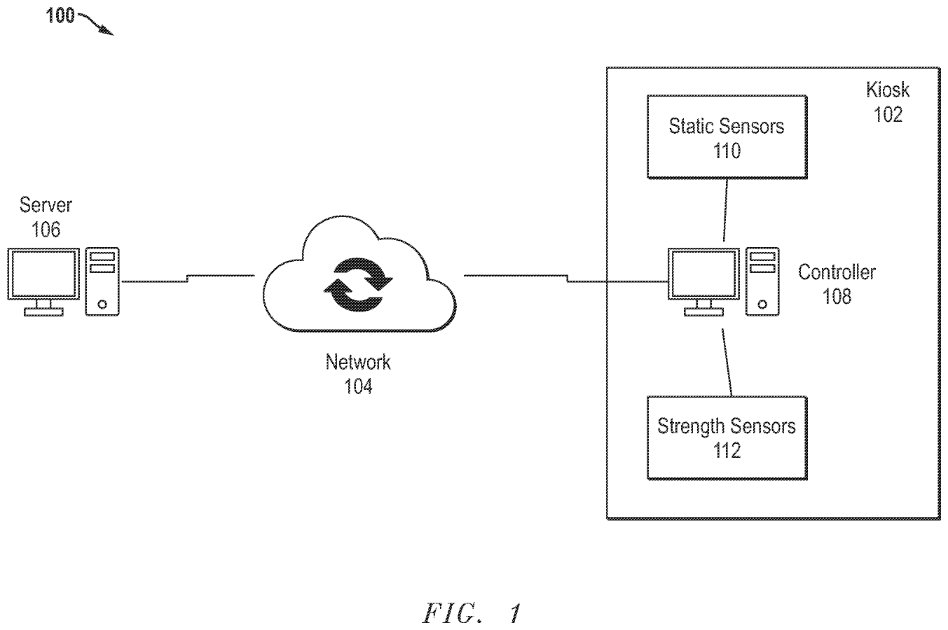

In FIG. 1, an example system 100 can be seen. This system 100 generally comprises a kiosk 102 that can communicate with a server 106 (e.g., WHICHBAT server) over a network 104 (which can be a switched packet network like the Internet). Generally, the kiosk 102 can be comprised of a controller 108, static sensors 110 (which can measure static physical characteristics like height and weight), and strength sensors 112 (which can measure indicia of strength of a user). There can be one or more static sensors 110 and one or more strength sensors 112.

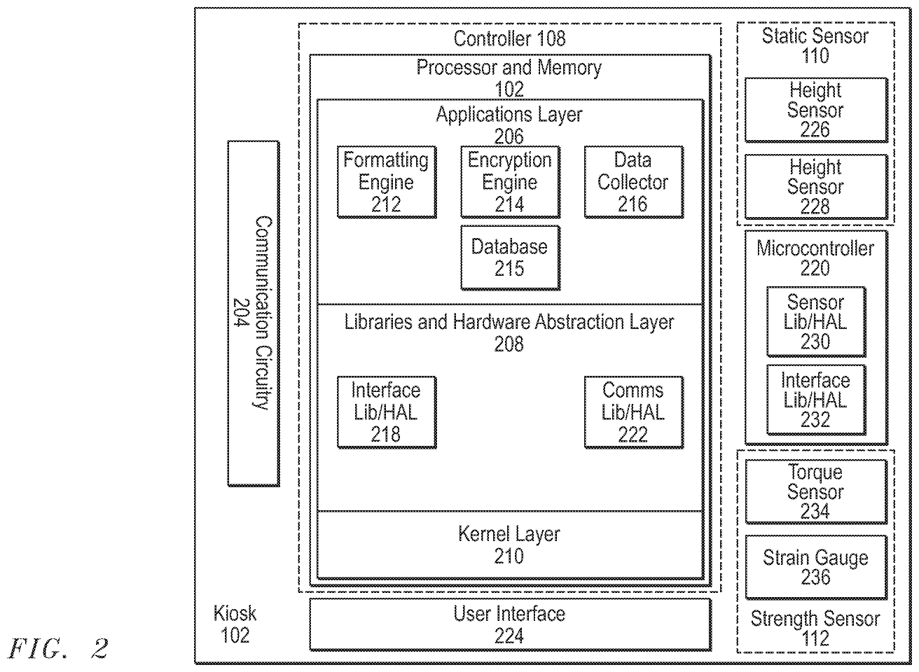

Turning to FIG. 2, a more detailed example of a kiosk 102 can be seen. In this example, the controller 108 can be comprised of a single board computer (such as a Beagle Bone Black or Raspberry Pi) with operating system operating thereon (such as Debian). Typically, though, the controller 108 can include a processor and memory (e.g., volatile and/or nonvolatile memory) 202 that can execute a software stack. The software stack generally comprises a kernel layer 210, a library/hardware abstraction layer (HAL) 208, and an application layer 206. Similarly, the microcontroller 220 (which operates as the sensor interface in this example) can include a software stack that includes a sensor HAL 230 and interface HAL 232. The controller 108 can also communicate with the user interface 224 (which is typically a touchscreen) through the communications HAL 222.

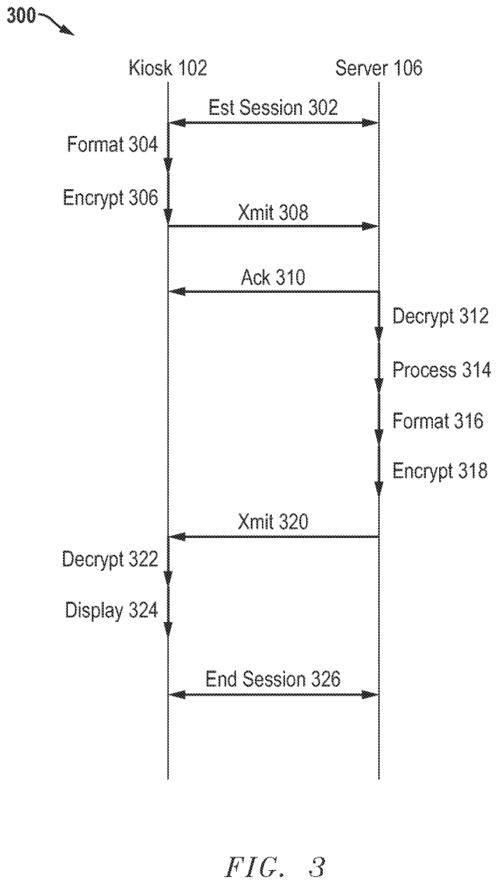

In operation (which can partially be seen in FIG. 3), a user can interact with the server 106 through the kiosk 102. The process can usually be initiated when a user interacts with the user interface 224 (e.g., presses a start button on a touchscreen). When initiated, a session can be established between the server 106 and the kiosk 102. When a session is established 302, a symmetric key (e.g., passcode) can be generated by the controller 108 in kiosk 102 and encrypted with one of the server's 106 public keys (e.g., 4096 RSA key). Additionally, the controller 108 can store unique key for the kiosk 102 to help ensure that only authorized terminals may be used. Typically, the encryption engine 214 (which is shown as being part of the application layer 206) is responsible for encryption, decryption, and key creation. Once the encrypted key is generated, it can be transmitted through communications HAL 222 and communications circuitry 204 (which can be wireless or wireline front end for communication with a modem or router). Typically, the server 106 will authorize a session with an acknowledge message when the kiosk 102 has been authorized and the symmetric key has been decrypted. Additionally, other data (such as age) can be keyed in through the interface 224.

Once a session has been established (in 302), operation of the kiosk 102 can begin. Typically, the data collector 216 will indicate to the microcontroller 220 an order of measurements. Both control and data can be transmitted between the microcontroller 220 and data collector 216 through the respective interface HALs 218 and 232. For example, the interface HALs 218 and 232 may be software to enable communications over Serial Peripheral Interface (SPI) or Inter-Integrated Circuit (I²C). Typically, the data collector 216 will have the sensor subsystem measure height (e.g. through the height sensor 226), weight (e.g, through weight sensor 228), and strength (e.g., through the strength sensor 112). Typically, the height can be measured using a camera, and the camera may also measure arm length. In general, the strength sensor 112 can use a torque sensor 234 and/or strain gauge(s) 236 to measure the pulling strength of the user. Additionally, the data collector 216 can display instruction on the interface

Once the measurement data has been collected, the it can be sent to the server 106. The formatting engine 212 (which is also show in this example to be part of the application layer 206) can format the measured data (e.g., height, weight, etc.) and keyed data into a transmit message (in 304). The encryption engine 214 can then encrypt the transmit message (in 306) using the symmetric key (generated in 302) and send it to the server (in 308) through communications HAL 222 and communications circuitry 204. An acknowledge message can then in sent in 310. On the server 106, the message can be decrypted (in 312), processed (in 314), formatted (in 316), encrypted (in 318), and transmitted (in 320). Once the receive message has been received, the encryption engine 214 can decrypt the message with the symmetric session key. The formatting engine 212 can unpack the decrypted receive message (in 322) and use data from the database 215 to generate an ordered list of bats, which reflects the best bat for the user based on measured and/or keyed-in data. This ordered data can then be displayed on the interface 224. The session can then be ended in 326, where the session key is destroyed. Additionally, the kiosk 102 can also access a retailer's inventory network or external e-commerce suppliers to allow the user to purchase a bat on-site or order it.

Having thus described the present disclosure by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present disclosure may be employed without a corresponding use of the other features. Accordingly, it is appropriate that the appended claims be construed broadly and in a manner consistent with the scope of the disclosure.

1. An apparatus comprising:
an interface;
a static sensor that is configured to measure height and weight of a user;
a strength sensor that is configured to measure an indicia of strength of the user;
a sensor interface that is in communication with the static sensor and the strength sensor;
communication circuitry that is configured to communicate with a network;
a controller that is in communication with the sensor interface and the communication circuitry, wherein the controller includes:
a data collector that is configured to receive sensor data from the sensor interface, wherein the sensor data the height, weight, and indicia of strength;
a database that is configured to include bat data for a plurality of bats;
a formatter that is configured to:
generate a transmission message that includes the height, the weight, and the indicia of strength;
communicate with the database;
receive decrypted display data; and
generate display data from the bat data and the decrypted display data; and
an encryption engine that is configured to:
encrypt the transmission message; and
decrypt a receive message to generate the decrypted display data.

2. The apparatus of claim 1, wherein the controller further comprises a processor that is in communication with a memory.

3. The apparatus of claim 2, wherein the controller includes a software stack that includes:
a kernel layer;
an interface layer that is configured to communicate with the kernel layer; and
an application layer that includes the data collector, the database, the formatter, and the encryption layer, wherein the application layer is configured to communicate with the interface layer.

4. The apparatus of claim 3, wherein the sensor interface further comprises a microcontroller.

5. The apparatus of claim 4, wherein the software stack is a first software stack, and wherein the microcontroller further comprises a second software stack.

6. The apparatus of claim 5, wherein the static sensor further comprises:
a height sensor; and
a weight sensor.

7. The apparatus of claim 6, wherein the height sensor further comprises a camera.

8. The apparatus of claim 7, wherein second software stack further comprises:
a sensor hardware abstraction layer (HAL) that is configured to communication with the height sensor, the weight sensor, and the strength sensor; and
an interface HAL that is configured to communicate the sensor data to the controller.

9. The apparatus of claim 8, wherein the strength sensor further comprises a plurality of strength sensors.

10. A method comprising:
establishing a session with a server by a user, wherein the step of establishing includes:
generating a symmetric session key;
encrypting the symmetric session key with the server's public key to generate an encrypted session key; and
transmitting the encrypted session key to the server;
receiving a user's physical characteristics;
formatting the user's physical characteristics into a transmission message;
encrypting the transmission message to generate an encrypted transmission message with the symmetric session key;
transmitting the encrypted transmission message to the server;
receiving a receive message from the server;
decrypting the receive message with the symmetric session key into a decrypted message;
formatting the decrypted message into ordered bat data; and
displaying the ordered bat data.

11. The method of claim 10, wherein the step of encrypting further comprises encrypting the transmission message with Advanced Encryption Standard (AES).

12. The apparatus of claim 11, wherein the ordered bat data further comprises a listing of bats in an order based at least in part on the user's physical characteristics.

13. The method of claim 12, wherein the user's physical characteristics further comprises height, weight, age, and indicia of strength of a user.

14. An apparatus comprising:
a touchscreen interface;
height and weight sensors that are, respectively, configured to measure height and weight of a user;
a strength sensor that is configured to measure an indicia of strength of the user;
a sensor interface that is in communication with the static sensor and the strength;
communication circuitry that is configured to communicate with a network;
a controller that is in communication with the sensor interface and the communication circuitry, wherein the controller includes:
a data collector that is configured to receive sensor data from the sensor interface, wherein the sensor data the height, weight, and indicia of strength;
a database that is configured to include bat data for a plurality of bats;
a formatter that is configured to:
generate a transmission message that includes the height, the weight, and the indicia of strength;
communicate with the database;
receive decrypted display data; and
generate display data from the bat data and the decrypted display data; and
an encryption engine that is configured to:
generate a symmetric session key;
encrypt the symmetric session key with a public key;
encrypt the transmission message; and
decrypt a receive message to generate the decrypted display data.

15. The apparatus of claim 14, wherein the controller includes a software stack that includes:
a kernel layer;
an interface layer that is configured to communicate with the kernel layer; and
an application layer that includes the data collector, the database, the formatter, and the encryption layer, wherein the application layer is configured to communicate with the interface layer.

16. The apparatus of claim 15, wherein the software stack is a first software stack, wherein sensor interface further comprises a microcontroller with a second software stack.

17. The apparatus of claim 16, wherein the height sensor further comprises a camera.

18. The apparatus of claim 17, wherein the second software stack further comprises:
a sensor hardware abstraction layer (HAL) that is configured to communication with the height sensor, the weight sensor, and the strength sensor; and
an interface HAL that is configured to communicate the sensor data to the controller.

19. The apparatus of claim 8, wherein the strength sensor further comprises a plurality of strength sensors.

20. The apparatus of claim 19, wherein the communication circuitry is a wireless front end that is configured to communicate with a wireless router.
